(19) United States
(12) Patent Application Publication
(10) Pub. No.: US 2010/0125587 A1
(43) Pub. Date: May 20, 2010

(54) ELECTRONIC FILE MANAGEMENT SYSTEM

(75) Inventors: Noriyuki Matsui, Kawasaki (JP); Misako Tanabe, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/572,572

(22) Filed: Oct. 2, 2009

(30) Foreign Application Priority Data
Nov. 17, 2008 (JP) 2008-293011

(51) Int. Cl. G06F 17/30; G06F 15/16; G06F 12/00

(52) U.S. Cl. 707/752; 709/206; 707/E17.01; 707/E17.032; 707/827

(57) ABSTRACT

An electronic file management system includes a terminal device and a management server. The terminal device includes a terminal storage, a data transmitter, and a first data delete unit. The terminal storage stores an electronic file. The data transmitter transmits the electronic file stored in the terminal storage. The first data delete unit deletes the electronic file stored in the terminal storage. The management server is communicably connected to the terminal device. The management server includes a data receiver and a data storage. The data receiver receives the electronic file from the terminal device. The data storage stores the electronic file received from the terminal device. The first data delete unit deletes the electronic file stored in the terminal storage after the data transmitter has transmitted the electronic file stored in the terminal storage to the management server.

### CROSS-REFERENCE TO RELATED APPLICATION

This application is based upon and claims the benefit of priority of the prior Japanese Patent Application No. 2008-293011, filed on Nov. 17, 2008, the entire contents of which are incorporated herein by reference.

### FIELD

The embodiments discussed herein are related to a technique for managing electronic files including personal information or confidential information, for example, in a company or the like.

### BACKGROUND

In recent years, there have been many cases in which personal information or confidential information is handled in the form of electronic data. The electronic data, regardless of whether or not it includes personal information or confidential information, is often stored in personal computers (hereinafter also referred to as “PCs”) managed by users such as employees in a company or the like. Despite that information leakage from personal computers causes serious social problems, how to store the data is left up to individual users and the electronic data stored in the personal computers is at risk of information leakage.

When a user receives an electronic mail (e-mail) or an electronic file including confidential information, the user may perform, currently, the following procedures, for example, to store the e-mail or the electronic file. The user refers to contents of the e-mail or the electronic file, and may manually make a special folder in mail environment to store the e-mail or the electronic file in the special folder when the e-mail or the electronic file includes confidential information. Alternatively, the user may manually transfer the e-mail or the electronic file including confidential information to another server or the like, and then manually deletes the e-mail or the electronic file from the mail environment in the user's personal computer. Examples are discussed in Japanese Laid-open Patent Publication No. 2004-179866 and Japanese Laid-open Patent Publication No. 2006-227898.

### SUMMARY

According to an aspect of the present invention, provided is an electronic file management system. The electronic file management system includes a terminal device and a management server.

The terminal device includes a terminal storage, a data transmitter, and a first data delete unit. The terminal storage stores an electronic file. The data transmitter transmits the electronic file stored in the terminal storage. The first data delete unit deletes the electronic file stored in the terminal storage.

The management server is communicably connected to the terminal device. The management server includes a data receiver and a data storage. The data receiver receives the electronic file from the terminal device. The data storage stores the electronic file received from the terminal device.

The first data delete unit deletes the electronic file stored in the terminal storage after the data transmitter has transmitted the electronic file stored in the terminal storage to the management server.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a system configuration of an electronic file management system according to an embodiment of the present invention;

FIG. 2 is a diagram illustrating an example of a configuration of a terminal device according to an embodiment of the present invention;

FIG. 3 is a diagram illustrating an example of a configuration of a management server according to an embodiment of the present invention;

FIG. 4 is a flowchart illustrating an example of an operation flow of an electronic file management system according to an embodiment of the present invention;

FIG. 5 is a flowchart illustrating a first example of an operation flow of a data sorter of a management server according to an embodiment of the present invention;

FIG. 6 is a flowchart illustrating a second example of an operation flow of a data sorter of a management server according to an embodiment of the present invention;

FIG. 7 is a diagram illustrating an example of a data storing method in a management server according to an embodiment of the present invention;

FIG. 8 is a diagram illustrating an example of the data storing method in an electronic file management system according to an embodiment of the present invention; and

FIG. 9 is a diagram illustrating an example of a system configuration of an electronic file management system according to an embodiment of the present invention.

### DESCRIPTION OF EMBODIMENTS

An operation related to storing and managing electronic data such as an electronic file including personal information or confidential information is performed by a manual operation of the user. When storing and managing the electronic data by such a manual operation, the user has to perform a plurality of steps of manual operation. Therefore, there is a high possibility that an operational human error occurs depending on a user's level and user's attention. The operational human errors include, for example, that the user forgets to store the electronic file which needs to be stored, that the user stores the electronic file to an incorrect storage, and that the user multiply stores the electronic file by forgetting to delete the electronic file. When such an operational human error occurs, a possibility of leaking personal information or confidential information included in the electronic file increases, and there is a risk that information security may not be maintained.

According to the embodiments, a user of a terminal device may only perform an operation for transmitting an electronic file to a management apparatus (also referred to as a management server), so that the electronic file is stored and managed in the management apparatus, and at the same time the electronic file may be automatically deleted from the terminal device without explicitly instructing to delete the electronic file. In this way, it may be possible to enable centralized management of electronic files while suppressing occurrence of operational human errors when storing an electronic file to maintain information security. Therefore secure management of electronic files including personal information or confidential information may be realized.

Hereinafter, an embodiment of the present invention will be discussed with reference to the drawings.

### (1) Configuration of the Embodiment

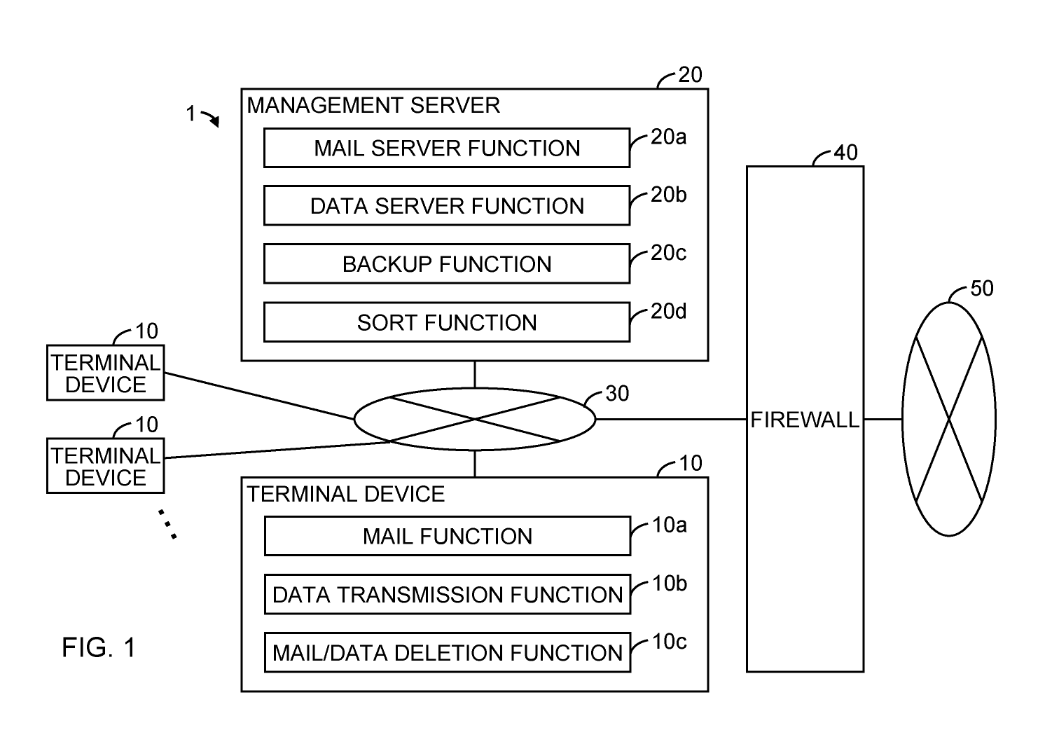

FIG. 1 is a diagram illustrating an example of a system configuration of an electronic file management system according to an embodiment of the present invention. The electronic file management system 1 illustrated in FIG. 1 is, for example, constructed as an in-house system of a company or the like, and includes a plurality of terminal devices 10 and a management server 20 communicably connected to each other via an intranet 30. Each terminal device 10 and the management server 20 may access the Internet 50 via a firewall 40.

As illustrated in FIG. 1, the terminal device 10 includes a mail function 10a, a data transmission function 10b, and a mail/data deletion function 10c.

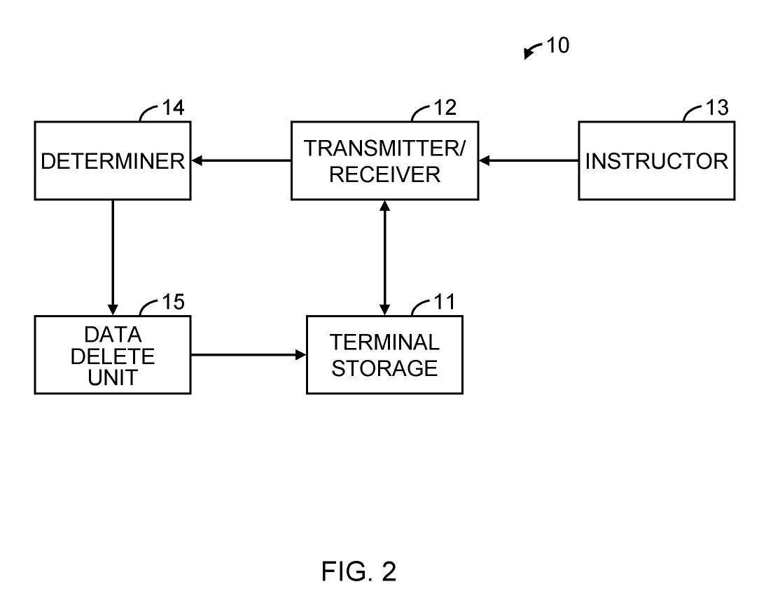

The mail function 10a is a function for transmitting/receiving an e-mail, and the data transmission function 10b is a function for attaching an electronic file to an e-mail to transmit the electronic file as data. These functions are realized by a transmitter/receiver 12, an instructor 13, and the like as discussed later with reference to FIG. 2. The mail/data deletion function 10c is a function for deleting data such as a mail and an electronic file in the terminal device 10, and is realized by a data delete unit 15 and the like as discussed later with reference to FIG. 2.

As illustrated in FIG. 1, the management server 20 includes a mail server function 20a, a data server function 20b, a backup function 20c, and a sort function 20d.

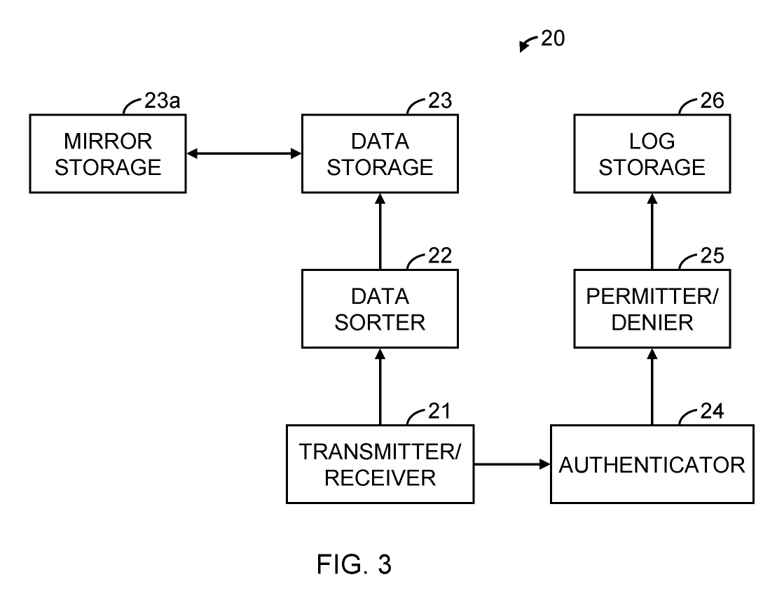

The mail server function 20a causes the management server 20 to function as a dedicated mail server in the in-house system, and also provides a function as a transmitter/receiver 21 or the like as discussed later with reference to FIG. 3.

The data server function 20b is a function for managing data such as electronic files stored in the management server 20, and causes the management server 20 to function as a data server in the in-house system. The data server function 20b provides functions as an authenticator 24, a permitter/denier 25, and a log storage 26 as discussed later with reference to FIG. 3.

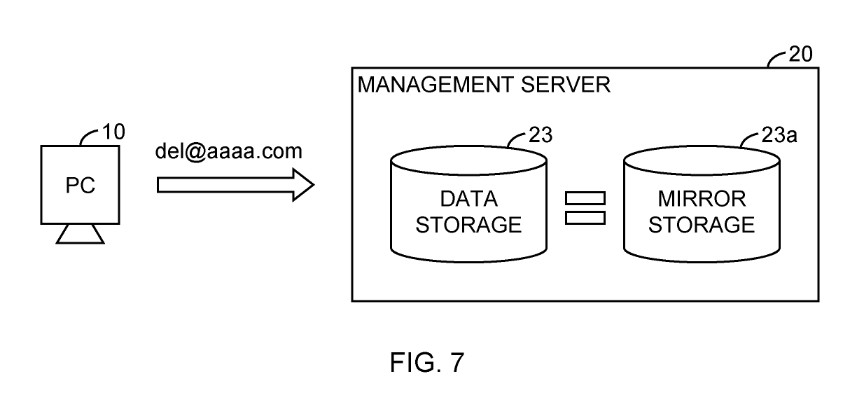

The backup function 20c is a function for backing up data such as the electronic files and the like stored in the management server 20, and is realized by using a mirror storage 23a or the like as discussed later with reference to FIGS. 3 and 7.

The sort function 20d is a function for sorting and storing e-mails received by the mail server function 20a of the management server 20 in pertinent folders, and the sort function 20d performs a function as a data sorter 22 as discussed later with reference to FIGS. 3, 5, and 6.

FIG. 2 is a diagram illustrating an example of a configuration of a terminal device according to an embodiment of the present invention. Each terminal device 10 illustrated in FIG. 2 may be, for example, a PC used by users such as employees in an in-house system of a company or the like, which has a functional configuration of a general PC and includes a terminal storage 11, a transmitter/receiver 12, an instructor 13, a determiner 14, and a data delete unit 15.

The terminal storage 11 includes a random access memory (RAM), a hard disk, and the like, and stores various data. In particular, the terminal storage 11 of the embodiment stores electronic files created by users and electronic files received as attached files of e-mails.

The transmitter/receiver 12 is included in a general PC, and performs the mail function 10a for transmitting/receiving e-mails, which is realized by a processor such as a central processing unit (CPU) or the like included in the terminal device 10 by executing mail software. In particular, the transmitter/receiver 12 of the embodiment functions as a transmitter for attaching an electronic file stored in the terminal storage 11 to an e-mail having a mail address specified by the instructor 13 discussed later as a destination address, and transmitting the e-mail to the management server 20, in accordance with an instruction from the instructor 13. The electronic file to be attached to the e-mail is also specified by the instructor 13.

The instructor 13 includes input devices such as a keyboard and a mouse operated by a user, and an input interface function realized by the processor of the terminal device 10 by executing a predefined program for handling an instruction signal received from the input devices to input the instruction signal into the terminal device 10. In particular, the instructor 13 of the embodiment performs a function for selecting, from the terminal storage 11, an electronic file to be attached to an e-mail transmitted by the transmitter/receiver 12 and specifying the selected electronic file to the transmitter/receiver 12. The instructor 13 of the embodiment also performs a function for specifying a destination of the e-mail, that is, the destination of the attached electronic file, to the transmitter/receiver 12.

At this time, when the user desires to bring a specific electronic file under centralized management of the management server 20, the user may specify the specific file via the instructor 13, which instructs the transmitter/receiver 12 to attach the specific file to an e-mail and transmit the e-mail. The user also specifies an mail address (for example, del@aaaa.com) under the control of the mail server function 20a of the management server 20 as a destination address of the e-mail, that is, the destination of the electronic file, to the transmitter/receiver 12 via the instructor 13.

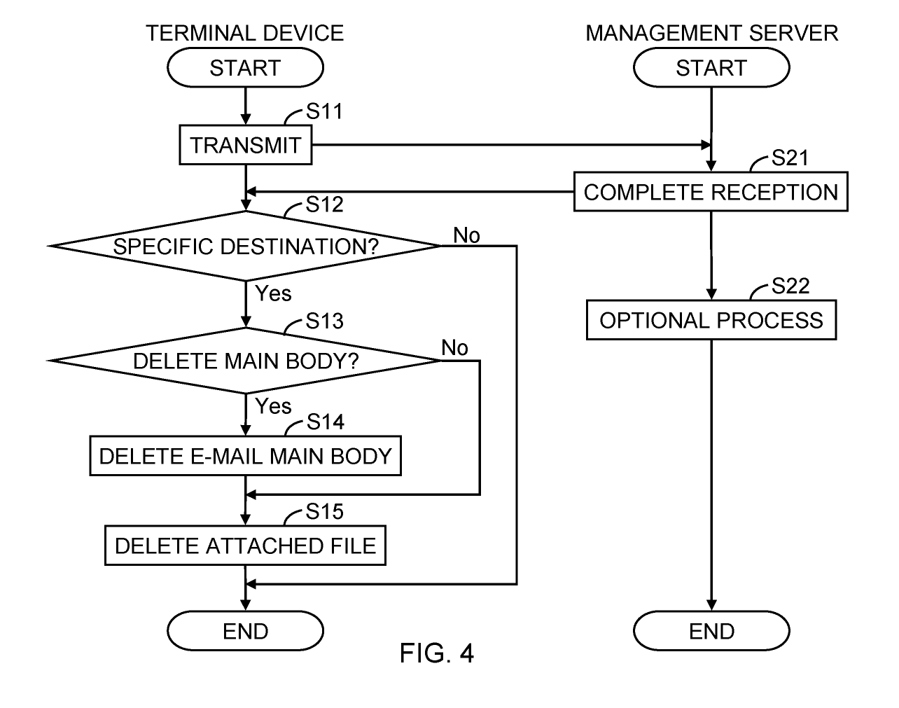

As discussed later with reference to FIG. 4, when the determiner 14 receives from the management server 20 a reception completion notification indicating that the e-mail with the attached electronic file has been received, the determiner 14 determines whether the destination of the received electronic file is the management server 20. In particular, the determiner 14 of the embodiment determines whether the destination of the electronic file is the management server 20 in accordance with the mail address specified by the instructor 13. The determiner 14 determines that the destination of the electronic file is the management server 20 when the destination address of the e-mail is a mail address under the control of the mail server function 20a of the management server 20. The function as the determiner 14 is realized by the processor of the terminal device 10 by executing a predefined program.

When the determiner 14 determines that the destination of the electronic file is the management server 20, in other words, determines that the electronic file is placed under the management of the management server 20, the data delete unit 15 deletes and clears the electronic file from the terminal storage 11, in other words, from the terminal device 10. In addition to clearing the electronic file, the data delete unit 15 of the embodiment is configured to be able to delete and clear the e-mail main body to which the electronic file is attached, as discussed later with reference to FIG. 4. The function as the data delete unit 15 is also realized by the processor of the terminal device 10 by executing a predefined program.

Whether the data delete unit 15 is to delete the e-mail main body or not may, for example, be specified in the data delete unit 15 in advance by the user or an administrator. However, it is preferable to specify that the e-mail main body is always deleted because text (main body) of the e-mail may include personal information or confidential information when the attached electronic file includes personal information or confidential information.

FIG. 3 is a diagram illustrating an example of a configuration of a management server according to an embodiment of the present invention. The management server 20 illustrated in FIG. 3 may be, for example, an information processing apparatus such as a PC having a functional configuration of a general PC, and includes a transmitter/receiver 21, a data sorter 22, a data storage 23, a mirror storage 23a, an authenticator 24, a permitter/denier 25, and a log storage 26.

The transmitter/receiver 21 is provided by the mail server function 20a discussed above, and in the embodiment, functions as a receiver for receiving an e-mail transmitted from the terminal device 10 and an electronic file attached to the e-mail. The function as the transmitter/receiver 21 and the mail server function 20a are realized by a processor including CPU or the like of the management server 20 by executing predefined programs.

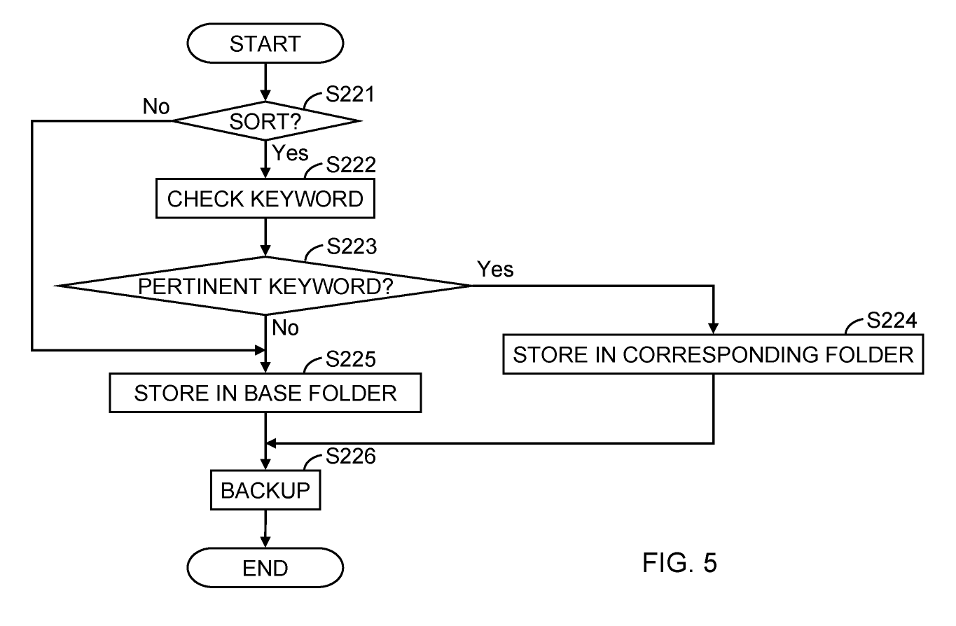

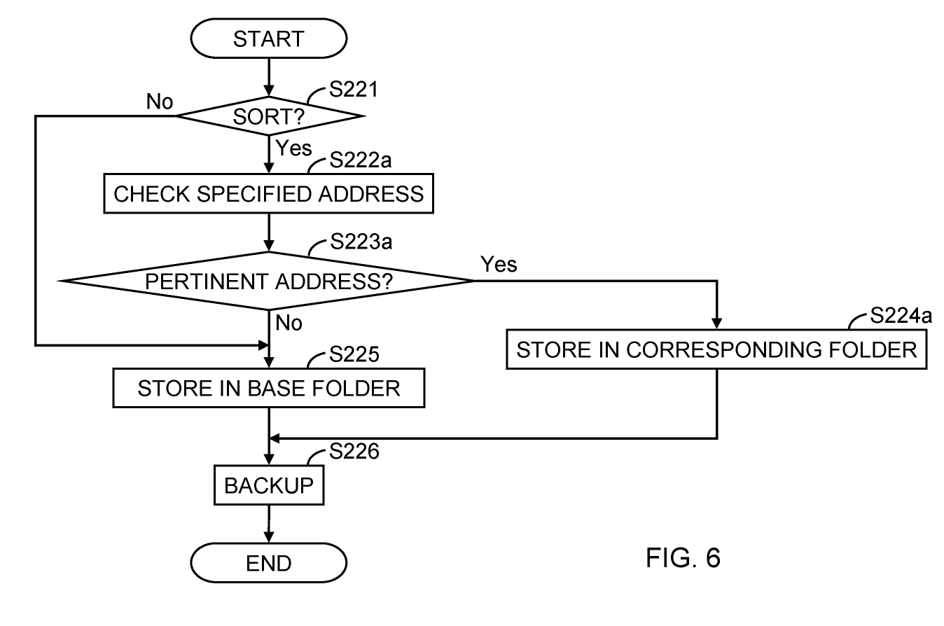

The data sorter 22 sorts the electronic file attached to the e-mail, and stores the electronic file in one of a plurality of folders provided in the data storage 23. As discussed later with reference to FIGS. 5 and 6, the data sorter 22 sorts the electronic file in accordance with, for example, at least one of a file name of the electronic file, a subject of the e-mail to which the electronic file is attached, and a destination address of the e-mail.

Whether the data sorter performs sorting may be determined by the administrator or the like of the electronic file management system 1 in advance and specified in the management server 20, or may be specified for each electronic file by the user who transmits the electronic file. The plurality of folders are provided in the data storage 23 by the administrator or the like of the electronic file management system 1 in advance. The function as the data sorter 22 is realized by the processor of the management server 20 by executing a predefined program.

The data storage 23 includes a RAM, a hard disk, and the like. The data storage 23 has the plurality of folders discussed above and a base folder used when a setting that the data sorter 22 dose not perform sorting is specified. The electronic file received by the transmitter/receiver 21 as an attached file of an e-mail is stored in one of these folders.

The mirror storage 23a backs up electronic files stored in the data storage 23. FIG. 7 is a diagram illustrating an example of a data storing method in a management server according to an embodiment of the present invention. In the management server 20, electronic files received by the transmitter/receiver 21 are, as illustrated in FIG. 7, stored in the data storage 23, and mirrored and backed up in the mirror storage 23a by the backup function 20c. The backup operation of the mirror storage 23a may be performed every time a new electronic file is stored in the data storage 23 or an electronic file is updated, or may be performed every predefined period.

The authenticator 24 authenticates, in accordance with authentication information inputted by a user such as an employee or the like, that the user is a valid user registered in advance. As the authentication information, for example, an identification number (ID), and a password or biological information such as a fingerprint, a palm print, iris data, a vein image, or the like are inputted. The authentication information is inputted via the intranet 30 from the terminal device 10 by the user such as an employee when the user logs in the management server 20 in order to access an electronic file stored in the data storage 23, or the authentication information is directly inputted into the management server 20.

In the management server 20, a registered password or registered biological information of the valid user corresponding to the identification number is stored in the storage or the like in advance as registered information in association with the identification number.

When the authentication information is inputted by the user, the authenticator 24 reads the registered information associated with the identification number of the inputted authentication information, and compares the read registered information with the password or biological information of the inputted authentication information. As a result of the comparison, when the inputted information matches the registered information, the authenticator 24 authenticates that the user is a valid user registered in advance. On the other hand, when the inputted information does not match the registered information as the result of the comparison, the authenticator 24 does not authenticate that the user is a valid user registered in advance.

When the user is authenticated as a valid user by the authenticator 24, the permitter/denier 25 permits the user to log in the management server 20, specifically, to access the electronic file in the data storage 23. On the other hand, when the user is not authenticated as a valid user by the authenticator 24, the permitter/denier 25 denies the user to log in the management server 20, specifically, to access the electronic file in the data storage 23.

The functions as the authenticator 24 and the permitter/denier 25 are realized by the processor of the management server 20 by executing predefined programs.

The log storage 26 records and stores the authentication result of the authenticator 24 and the contents of the access permitted by the permitter/denier 25 as an access log. The function as the log storage 26 is also realized by the processor of the management server 20 by executing a predefined program.

### (2) Operations in the Embodiment

Operations of the electronic file management system 1 configured as discussed above, specifically, operations of the terminal device 10 and the management server 20 will be discussed with reference to FIGS. 4 to 7.

FIG. 4 is a flowchart illustrating an example of an operation flow of an electronic file management system according to an embodiment of the present invention. Operations of the electronic file management system 1 illustrated in FIG. 1 will be discussed in accordance with a flowchart illustrated in FIG. 4.

In operation S11, when a user recognizes that an electronic file including personal information or confidential information is stored in the terminal device 10 used by the user, and tries to place the electronic file under the centralized management of the management server 20, the user operates the input devices serving as the instructor 13 to instruct the transmitter/receiver 12 as follows. The user specifies the electronic file and a predefined mail address (for example, del@aaaa.com) via the instructor 13 of the terminal device 10, and instructs the transmitter/receiver 12 to attach the electronic file to an e-mail and transmit the e-mail to the management server 20. The transmitter/receiver 12 which has received such an instruction performs, in accordance with the instruction, a transmission process in which the specified electronic file is attached to an e-mail and the e-mail is transmitted in accordance with the predefined mail address del@aaaa.com to the management server 20.

In operation S21, upon completing reception of the e-mail with the attached electronic file, the management server 20 as the destination of the e-mail transmits a reception completion notification to the terminal device 10 as the source of the e-mail.

In operation S12, when the terminal device 10 has received the reception completion notification from the management server 20, the determiner 14 determines whether the destination of the electronic file which has been transmitted and received is the management server 20. Specifically, the determiner 14 determines that the destination of the electronic file is the management server 20 when a destination address of the e-mail is the mail address del@aaaa.com under the control of the mail server function 20a of the management server 20.

When the determiner 14 determines that the destination address of the e-mail is not “del@aaaa.com” and the destination of the electronic file is not the management server 20 (“No” in operation S12), the terminal device 10 terminates the process.

In operation S13, when the determiner 14 determines that the destination address of the e-mail is “del@aaaa.com” and the destination of the electronic file is the management server 20 (“Yes” in operation S12), the data delete unit 15 determines whether a deletion setting of the e-mail main body is specified. When the deletion setting of the e-mail main body is not specified (“No” in operation S13), the terminal device 10 advances the process to operation S15.

In operation S14, when the deletion setting of the e-mail main body is specified (“Yes” in operation S13), the data delete unit 15 deletes, from the terminal storage 11, the main body of the e-mail transmitted to the management server 20 in operation S11 to clear the e-mail main body from the terminal device 10.

In operation S15, the data delete unit 15 deletes and clears the electronic file attached to the e-mail deleted in operation S14 from the terminal storage 11, in other words, from the terminal device 10. In this way, the electronic file is placed under the management of the management server 20.

If the reception completion notification is not transmitted from the management server 20 when a predefined time has passed after the transmission process in operation S11, the user is informed accordingly at the terminal device 10, and the terminal device 10 terminates the process.

When the data delete unit 15 performs the deletion, the e-mail main body and the electronic file may be temporarily moved to a delete folder, and after a series of operations S11 to S15 are completed, in other words, after a predefined program has been executed, data in the delete folder may be deleted.

In operation S22, in the management server 20 which has received the electronic file from the terminal device 10 in operation S21, an automatic sorting process of electronic files and a backup process are performed as optional processes), which are discussed below with reference to FIGS. 5 and 6.

FIG. 5 is a flowchart illustrating a first example of an operation flow of a data sorter of a management server according to an embodiment of the present invention.

In a first example illustrated in FIG. 5, folders corresponding to various keywords are provided in the data storage 23 in advance. On the assumption that the user writes a keyword in the subject of the e-mail or the file name of the electronic file to perform the file transmission, the management server 20 performs the following process.

In operation S221, upon receiving an e-mail with an attached electronic file, the management server 20 determines whether a setting for performing sorting is specified. When the setting for performing sorting is not specified (“No” in operation S221), the management server 20 advances the process to operation S225.

In operation S222, when the setting for performing sorting is specified (“Yes” in operation S221), the data sorter 22 checks whether a keyword is written in the subject of the e-mail or the file name of the electronic file.

In operation S223, the data sorter 22 determines whether the keyword corresponds to a folder.

In operation S224, when a keyword corresponding to a folder is written in the subject or the file name (“Yes” in operation S223), the data sorter 22 stores the electronic file in the folder corresponding to the keyword. Then, the management server 20 advances the process to operation S226.

In operation S225, when a keyword is not written in the subject or the file name (“No” in operation S223), or the setting for performing sorting is not specified (“No” in operation S221), the management server 20 stores the attached file in the base folder of the data storage 23.

In operation S226, the management server 20 stores and backs up the stored electronic file in the mirror storage 23a (refer to FIG. 7).

FIG. 6 is a flowchart illustrating a second example of an operation flow of a data sorter of a management server according to an embodiment of the present invention.

In a second example illustrated in FIG. 6, a plurality of mail addresses to the management server 20 are defined for sorting, and folders corresponding to each mail address are provided in the data storage 23. On the assumption that the user selects, to specify the destination, a mail address corresponding to a folder in which the user desires to store the electronic file, the management server 20 performs the following process.

In operation S221, upon receiving an e-mail with an attached electronic file, the management server 20 determines whether a setting for performing sorting is specified.

In operation S222a, when the setting for performing sorting is specified (“Yes” in operation S221), the data sorter 22 checks whether a destination address of the e-mail is for sorting.

In operation S223a, the data sorter 22 determines whether the destination address corresponds to a folder for sorting.

In operation S224a, when the destination address corresponds to a folder for sorting (“Yes” in operation S223a), the data sorter 22 stores the electronic file in the folder corresponding to the destination address. Then, the management server 20 advances the process to operation S226.

In operation S225, when the destination address of the e-mail does not correspond to a folder for sorting (“No” in operation S223a), or the setting for performing sorting is not specified (“No” in operation S221), the management server 20 stores the attached file in the base folder of the data storage 23.

In operation S226, the management server 20 stores and backs up the stored electronic file in the mirror storage 23a (refer to FIG. 7).

As discussed above, the management server 20, which functions as a dedicated mail server, also functions as a storage system for electronic files in the embodiment. The electronic file specified by the user and transmitted to the management server 20 is stored and centrally managed in the management server 20.

The electronic files stored in the management server 20 are shared by users such as, for example, employees in a company, under security management as follows:

When a user accesses an electronic file stored in the management server 20, the user logs in the management server 20 from the user's terminal device 10 via the intranet 30. When logging in, the user inputs an identification number and a password as authentication information. Instead of a password, biological information of the user may be used.

When the identification number and the password are inputted, in the management server 20, the authenticator 24 reads a registered password corresponding to the inputted identification number and compares the inputted password with the read registered password.

As a result of the comparison, when the inputted password matches the registered password, the authenticator 24 authenticates that the user is a valid user registered in advance, and the permitter/denier 25 permits the user to access the electronic file stored in the data storage 23. On the other hand, when the inputted password does not match the registered password, the authenticator 24 does not authenticate that the user is a valid user registered in advance, and the permitter/denier 25 denies the user to access the electronic file stored in the data storage 23.

In this way, the management server 20 is used as a shared file server having a security function including access control. Specifically, the electronic files stored in the data storage 23 are centrally managed by the management server 20, and shared by valid users such as employees in a company while maintaining security on the management server 20.

At this time, the authentication result of the authenticator 24 and the contents of the access permitted by the permitter/denier 25 are recorded and stored as an access log in the log storage 26.

### (3) Advantages of the Embodiment

As discussed above, according to the embodiment, the user of the terminal device 10 only has to perform an operation for transmitting an electronic file to the management server 20, so that the electronic file is sorted and stored in the management server 20, and at the same time the electronic file is automatically deleted and cleared from the user's terminal device 10 without explicitly instructing deletion of the electronic file. In this way, it is possible to suppress occurrence of operational human error in a storing operation of the electronic file, and realize centralized management of electronic files while maintaining information security. Therefore secure management of electronic files including personal information or confidential information is realized.

As discussed above, when storing the electronic file in the management server 20, the electronic file may be stored and managed in a desired folder in accordance with a keyword written in the subject of the e-mail or the file name of the electronic file, or a mail address for sorting specified as a destination address of the e-mail. Therefore, when logging in the management server 20 and using the electronic file after storing the electronic file in the management server 20, it is easy to identify the stored location of the electronic file, so that the user's usability may be improved.

Furthermore, since the authentication result of the authenticator 24 and the contents of the access permitted by the permitter/denier 25 are recorded and stored as an access log in the log storage 26, it is possible to construct a security system having higher security. In the event that any illegal access to the electronic file stored in the management server 20 occurs, it is possible to analyze and clarify the illegal access in accordance with the recorded contents in the log storage 26.

### (4) Modified Example

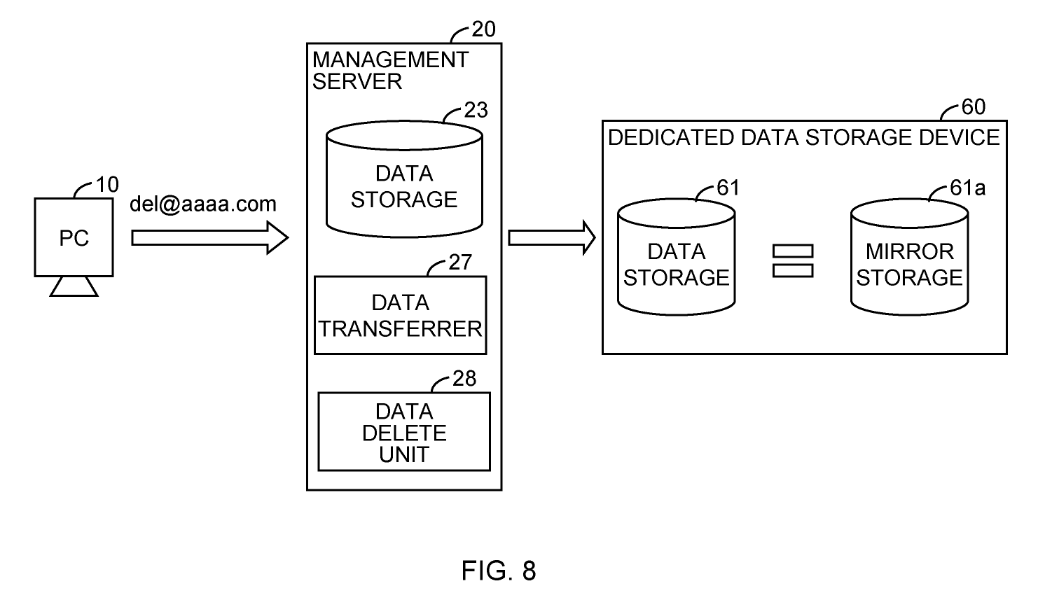

In the embodiment discussed above with reference to the FIGS. 1 to 7, an example in which the management server 20 functioning as a dedicated mail server also functions as a storage system of electronic files is discussed. However, the embodiment may be configured to store electronic files as illustrated in FIG. 8. FIG. 8 is a diagram illustrating an example of the data storing method in an electronic file management system according to an embodiment of the present invention.

The example illustrated in FIG. 8 includes a dedicated data storage device 60 for storing electronic files in addition to the management server 20. The management server 20 is communicably connected to the dedicated data storage device 60 directly or via the intranet 30. The management server 20 further includes a data transferrer 27 and a data delete unit 28.

Here, the data transferrer 27 transfers an electronic file stored in the data storage 23 to the dedicated data storage device 60. The data delete unit 28 deletes and clears the electronic file from the data storage 23 when the data transferrer 27 completes the transfer of the electronic file to the dedicated data storage device 60. In this case, the mirror storage 23a illustrated in FIGS. 3 and 7 in the management server 20 is omitted. The function as the data transferrer 27 is included in the backup function 20c.

The dedicated data storage device 60 includes a data storage 61 and a mirror storage 61a. These data storage 61 and the mirror storage 61a are similar to the data storage 23 and the mirror storage 23a discussed above, respectively.

The data storage 61 includes a hard disk or the like, and stores electronic files transferred from the data transferrer 27. A plurality of folders for sorting and a base folder as discussed above may also be provided in the data storage 61 in advance as necessary.

The mirror storage 61a backs up electronic files stored in the data storage 61. In the dedicated data storage device 60, as illustrated in FIG. 8, the electronic files transferred from the data transferrer 27 are stored in the data storage 61, and mirrored and backed up in the mirror storage 61a.

Every time the management server 20 receives an electronic file from the terminal device 10, the data transferrer 27 may transfer the electronic file to the dedicated data storage device 60. In this case, the data storage 23 in the management server 20 may also be omitted. The data transferrer 27 may transfer a set of electronic files to the dedicated data storage device 60 every predefined period.

As discussed above, in the modified example illustrated in FIG. 8, the electronic file transferred to the dedicated data storage device 60 from the data transferrer 27 is cleared from the management server 20 by the data delete unit 28. Therefore, since the e-mail transmitted from the terminal device 10 to the management server 20 is stored only in the dedicated data storage device 60 in the electronic file management system 1 and managed centrally, the same operational advantages as those of the embodiment discussed above may be obtained.

When a user uses an electronic file stored in the dedicated data storage device 60, in the same way as discussed above, the user inputs authentication information into the management server 20 and logs in the management server 20, and thereafter reads and uses the electronic file from the dedicated data storage device 60 via the management server 20.

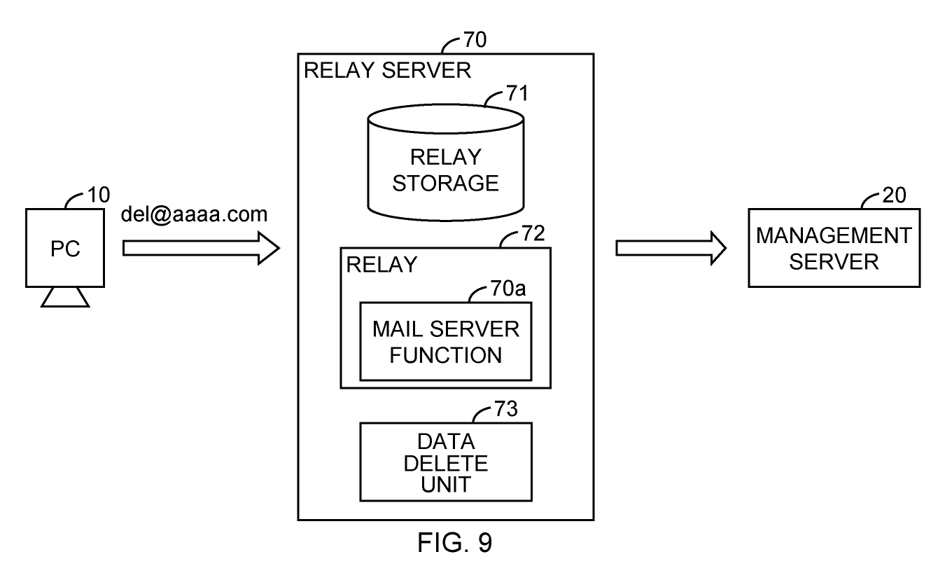

FIG. 9 is a diagram illustrating an example of a system configuration of an electronic file management system according to an embodiment of the present invention.

In a modified example illustrated in FIG. 9, between the terminal device 10 and the management server 20, there is a relay server 70 for temporarily storing the electronic file transmitted from the terminal device 10 to the management server 20 in order to relay the electronic file.

The relay server 70 includes at least a relay storage 71, a relay 72, and a data delete unit 73.

The relay storage 71 temporarily stores the electronic file to be relayed from the terminal device 10 to the management server 20.

In the example illustrated in FIG. 9, it is assumed that the function of the relay 72 includes a mail server function 70a. In this case, the instructor 13 of the terminal device 10 specifies, as the destination of the electronic file, a mail address of the management server 20, which is under the control of the mail server function 70a of the relay 72. The transmitter/receiver 12 of the terminal device 10 attaches the electronic file to an e-mail having the mail address specified by the instructor 13 as the destination address and transmits the e-mail to the management server 20 via the relay server 70.

The data delete unit 73 deletes and clears the electronic file from the relay storage 71, in other words, from the relay server 70 when the transmission of the electronic file to the management server 20 is completed.

In the modified example illustrated in FIG. 9, the electronic file which is transmitted from the terminal device 10, relayed by the relay server 70, and transmitted to the management server 20 is deleted from the relay server 70 by the data delete unit 73. Therefore, since the e-mail transmitted from the terminal device 10 to the management server 20 is stored only in the management server 20 in the electronic file management system 1 and managed centrally, the same operational advantages as those of the embodiment discussed above may be obtained.

### (5) Others

The present invention is not limited to the embodiment discussed above, and various modifications may be implemented without departing from the scope of the invention.

All or a part of the functions of the transmitter/receiver 12, the instructor 13, the determiner 14, the data delete unit 15, the transmitter/receiver 21, the data sorter 22, the storages 23 and 23a, the authenticator 24, the permitter/denier 25, the log storage 26, and the data transferrer 27 discussed above may be realized by a computer which includes a CPU, an information processing apparatus, and various terminals, by executing a predefined application program.

The program is provided in a form in which the program is recorded in a computer-readable recording medium such as, for example, a flexible disk, a compact disc (CD) including CD-ROM, CD-R, CD-RW, and the like, and a digital versatile disc (DVD) including DVD-ROM, DVD-RAM, DVD-R, DVD-RW, DVD+R, DVD+RW, Blu-ray Disc, and the like. In this case, the computer reads the program from the recording medium, and transmits and stores the program in an internal storage device or an external storage device to use the program. Also, the program may be recorded in a storage device (recording medium) such as, for example, a magnetic disk, an optical disk, a magnet-optical disk, and the like, so that the program is provided from the storage device to the computer via a communication line.

Here, the computer is a concept including hardware and an operating system (OS), and means the hardware working under the control of the OS. When the OS is not required, and the application program independently operates the hardware, the hardware itself is equivalent to the computer. The hardware includes at least a microprocessor such as a CPU and means for reading a computer program recorded in a recording medium. The program includes program codes for causing a computer as discussed above to realize functions of the transmitter/receiver 12, the instructor 13, the determiner 14, the data delete unit 15, the transmitter/receiver 21, the data sorter 22, the storages 23 and 23a, the authenticator 24, the permitter/denier 25, the log storage 26, and the data transferrer 27. A part of the functions may be realized by the OS other than the application program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a illustrating of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. An electronic file management system comprising:
a terminal device including:
a terminal storage for storing an electronic file,
a data transmitter for transmitting the electronic file stored in the terminal storage, and
a first data delete unit for deleting the electronic file stored in the terminal storage; and
a management server communicably connected to the terminal device, the management server including:
a data receiver for receiving the electronic file from the terminal device, and
data storage for storing the electronic file received from the terminal device,
wherein
the first data delete unit deletes the electronic file stored in the terminal storage after the data transmitter has transmitted the electronic file stored in the terminal storage to the management server.

2. The electronic file management system of claim 1, wherein
the management server performs functions of a mail server,
the data transmitter transmits the electronic file stored in the terminal storage, the electronic file being attached to a mail with a mail address under the control of the management server as a destination address, and
the first data delete unit deletes the electronic file stored in the terminal storage after the data transmitter has transmitted the mail to the management server.

3. The electronic file management system of claim 1, further comprising:
a relay server including:
a relay storage for storing an electronic file, and
a relay for
receiving the electronic file transmitted from the terminal device,
storing the electronic file received from the terminal device in the relay storage, and
transmitting the electronic file received from the terminal device to the management server, and
a second data delete unit for deleting the electronic file stored in the relay storage after the relay has transmitted the electronic file received from the terminal device to the management server.

4. The electronic file management system of claim 3, wherein
the relay server performs functions of a mail server,
the data transmitter transmits the electronic file stored in the terminal storage as an attachment to a mail destined to a mail address of the management server, the mail address being under the control of the relay server,
the relay
receives the mail transmitted from the terminal device,
storing the electronic file attached to the mail received from the terminal device in the relay storage, and
transmitting the mail received from the terminal device to the management server, and
the second data delete unit deletes the electronic file stored in the relay storage after the relay has transmitted the mail received from the terminal device to the management server.

5. The electronic file management system of claim 2, wherein
the data storage includes a plurality of folders, and
the management server further includes
a data sorter for sorting a received electronic file received from the terminal device in accordance with at least one of a file name of the received electronic file, a subject of the mail, and the destination address of the mail, to store the received electronic file in one of the plurality of folders.

6. The electronic file management system of claim 1, wherein
the management server further includes:
an authenticator for determining whether a user is a valid user in accordance with authentication information inputted by the user,
a permitter for
permitting the user to access the electronic file stored in the data storage when it is determined that the user is a valid user, and
denying the user to access the electronic file stored in the data storage when it is determined that the user is an invalid user.

7. The electronic file management system of claim 6, wherein
the management server further includes
a log storage for storing at least one of an authentication result output from the authenticator and contents of access permitted by the permitter.

8. The electronic file management system of claim 1, wherein
the management server further includes
a mirror storage for backing up the electronic file stored in the data storage, and
the electronic file received from the terminal device is stored in the data storage and the mirror storage.

9. The electronic file management system of claim 1, further comprising:
a dedicated data storage device for storing the electronic file received from the terminal device,
wherein
the management server further includes
a data transferrer for transferring the electronic file stored in the data storage to the dedicated data storage device.

10. The electronic file management system of claim 9, wherein
the management server further includes
a third data delete unit for deleting the electronic file stored in the data storage after the data transferrer has transferred the electronic file stored in the data storage to the dedicated data storage device.

11. A terminal device communicably connected to a management server, the terminal device comprising:
a terminal storage for storing an electronic file;
a data transmitter for transmitting the electronic file stored in the terminal storage to the management server; and
a data delete unit for deleting the electronic file stored in the terminal storage after the data transmitter has transmitted the electronic file stored in the terminal storage to the management server.

12. The terminal device of claim 11, wherein
the management server performs functions of a mail server,
the data transmitter transmits the electronic file stored in the terminal storage, the electronic file being attached to a mail with a mail address under the control of the management server as a destination address, and
the data delete unit deletes the electronic file stored in the terminal storage after the data transmitter has transmitted the mail to the management server.

13. A computer-readable medium storing a program comprising computer-executable instructions enabling a computer to act as a terminal device communicably connected to a management server, the terminal device including:
a terminal storage for storing an electronic file,
a data transmitter for transmitting the electronic file stored in the terminal storage to the management server, and
a data delete unit for deleting the electronic file stored in the terminal storage after the data transmitter has transmitted the electronic file stored in the terminal storage to the management server.

14. The computer-readable medium of claim 13, wherein
the management server performs functions of a mail server,
the data transmitter transmits the electronic file stored in the terminal storage, the electronic file being attached to a mail with a mail address under the control of the management server as a destination address, and
the data delete unit deletes the electronic file stored in the terminal storage after the data transmitter has transmitted the mail to the management server.
